(19) United States
(12) Patent Application Publication
(10) Pub. No.: US 2012/0146571 A1
(43) Pub. Date: Jun. 14, 2012

(54) WATERPROOF BATTERY CHARGER

(75) Inventors: MIN-CHIEH HSU, Tu-Cheng (TW); YING-HAO HSU, Tu-Cheng (TW)

(73) Assignee: HON HAI PRECISION INDUSTRY CO., LTD., Tu-Cheng (TW)

(21) Appl. No.: 13/158,454

(22) Filed: Jun. 13, 2011

(30) Foreign Application Priority Data
Dec. 13, 2010 (TW) 99143430

(51) Int. Cl. H01M 10/46; H02J 7/00

(52) U.S. Cl. 320/101; 320/115

(57) ABSTRACT

A waterproof battery charger includes a housing and a charging assembly within the housing. The housing includes an upper housing defining a first recess and a lower housing defining a second recess. The lower housing are hinged together. The lower housing includes an elastic sealing layer that can be elastically deformed to provide a seal when the upper housing and the lower housing are closed together.

### BACKGROUND

1. Technical Field

The present disclosure relates to battery chargers and, particularly, to a waterproof battery charger.

2. Description of Related Art

Portable devices with rechargeable batteries are widely used. When the portable devices run out of electricity, a charger is needed to recharge the batteries thereof. To be able to charge batteries in unusual situations, it is necessary to provide a waterproof battery charger.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a waterproof battery charger according to an exemplary embodiment.

FIG. 2 is an exploded view of the waterproof battery charger of FIG. 1.

FIG. 3 is a view similar to FIG. 2, but viewed from a different perspective.

### DETAILED DESCRIPTION

Embodiments of the present disclosure are now described in detail, with reference to the accompanying drawings.

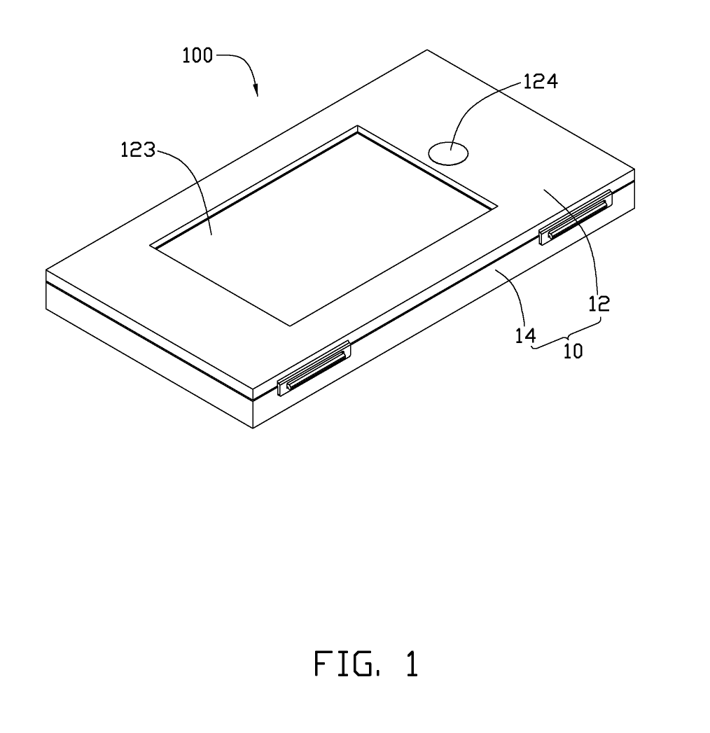

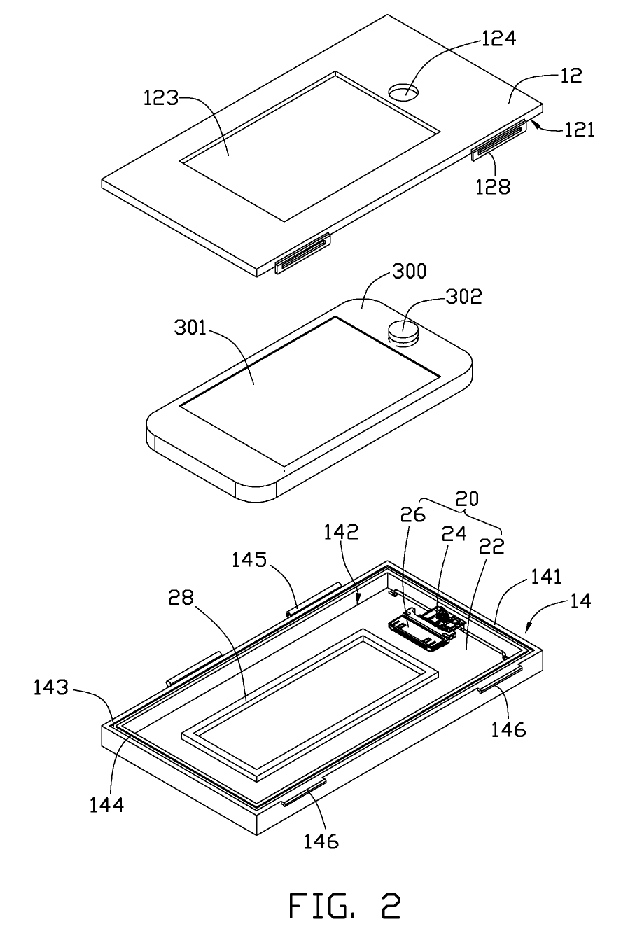

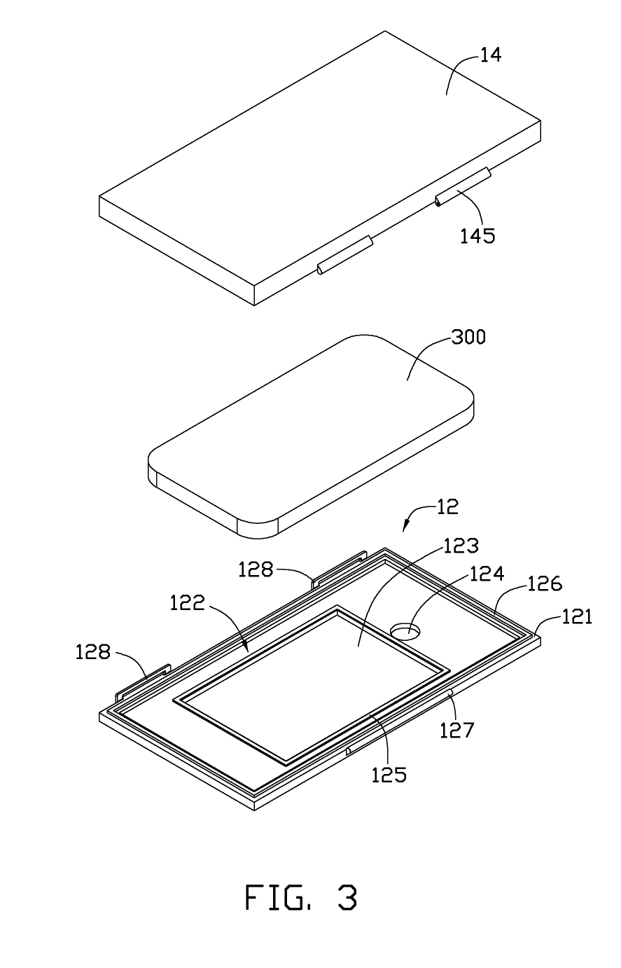

Referring to FIGS. 1-3, a waterproof battery charger 100 according to an exemplary embodiment is illustrated. The waterproof battery charger 100 includes a housing 10 and a charging assembly 20 retained within the housing 10. The housing 10 includes an upper housing 12 and a lower housing 14 coupled to each other. An electronic device 300 can be placed and retained between the upper housing 12 and the lower housing 14 and charged by the charging assembly 20. In the embodiment, the electronic device 300 is a cell phone and includes a touch screen 301 and a button 302.

The upper housing 12 is rectangular and includes a first surface 121 facing the lower housing 14. The first surface 121 defines a first recess 122 and a display opening 123 extending through the upper housing 12 and communicating with the first recess 122. The display opening 123 is arranged to expose the touch screen 301, such that a user can operate the electronic device 300 as it is being charged. The upper housing 12 includes an elastic portion 124 corresponding to the button 302 of the electronic device 300. In the embodiment, the elastic portion 124 is integrally formed with the upper housing 12. A user can operate the elastic portion 124 to depress the button 302 when the electronic device 300 is being charged. The upper housing 12 includes a sealing ring 125 inside the upper housing 12 and framing the edge of the display opening 123, and a protruding rib 126 around the first recess 122. Further, the upper housing 12 includes a first pivot side 127 and two engagement slots 128 on the opposite side.

The lower housing 14 includes a second surface 141 facing the upper housing 12. The second surface 141 defines a second recess 142 and a positioning groove 143 around the second recess 142. The lower housing 14 includes a sealing layer 144 in the positioning groove 143 which receives the protruding rib 126 of the upper housing 12. The lower housing 14 further includes a second pivot side 145 at one side and two protruding tabs 146 (respectively to engage the engagement slots 128 of the upper housing 12) on the other side. The first pivot side 127 and the second pivot side 145 are pivotally connected together, thereby hinging the upper housing 12 and the lower housing 14. When the protruding tabs 146 latch into the engagement slots 128, the sealing layer 144 is pressed by the protruding rib 126 and deforms elastically, thereby sealing the gap between the surfaces 121 and 141 and preventing the ingress of water or other undesirable substance.

In the embodiment, the lower housing 14 is made of transparent material, and the charging assembly 20 includes a solar panel 22, a controller 24, and a connector 26. The solar panel 22 is attached to the base of the second recess 142, and is disposed so as to gather any external light available. Thus, the controller 24 can generate electricity photovoltaically and transmit the generated electricity to the electronic device 300 via the connector 26.

After placing the electronic device 300 into the second recess 142 of the lower housing 14, the upper housing 12 is closed until the protruding tabs 146 latch into the engaging slots 128. The electronic device 300 tightly abuts the bottom of the first recess 122, and the sealing ring 125 is compressed between the electronic device 300 and the upper housing 12, thus sealing any gap between the upper housing 12 and the electronic device 300 and preventing the ingress of water or other undesirable substance.

The charging assembly 20 further includes a resilient member 28 disposed on the solar panel 22. In the embodiment, the resilient member 28 is made of flexible rubber or soft plastic. The resilient member 28 provides an elastic force against the electronic device 300 which presses it more firmly against the bottom of the first recess 122.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A waterproof battery charger configured to charge an electronic device, the waterproof battery charger comprising:
a housing comprising an upper housing defining a first recess and a lower housing defining a second recess and coupled to the upper housing, the lower housing comprising an elastic sealing layer that is able to be elastically deformed by the upper housing when the upper housing and the lower housing are coupled together, thereby sealing a gap between the upper housing and the lower housing and preventing the ingress of water or other undesirable substance; and
a charging assembly retained within the housing and configured to charge the electronic device placed inside the housing.

2. The waterproof battery charger as described in claim 1, wherein the upper housing comprises a first pivot side, and the lower housing comprises a second pivot side pivotally connected to the first pivot side, thereby hinging the upper housing and the lower housing together.

3. The waterproof battery charger as described in claim 2, wherein the upper housing comprises two engagement slots, and the lower housing comprises two protruding tabs to respectively engage with the engagement slots of the upper housing.

4. The waterproof battery charger as described in claim 1, wherein the lower housing defines a positioning groove receiving the sealing layer around the second recess, the upper housing forms a protruding rib, and when the protruding rib is received in the positioning groove, the sealing layer deforms elastically, thereby sealing the gap between the upper housing and the lower housing.

5. The waterproof battery charger as described in claim 1, wherein the upper housing defines a display opening communicating with the first recess and comprises a sealing ring around the edge of the display opening, and the sealing ring is capable of being compressed between the electronic device and the upper housing, thereby sealing a gap between the upper housing and the electronic device.

6. The waterproof battery charger as described in claim 1, wherein the upper housing comprises an elastic portion corresponding to a button of the electronic device and to be operated by users to depress the button of the electronic device.

7. The waterproof battery charger as described in claim 6, wherein the elastic portion is integrally formed with the upper housing.

8. The waterproof battery charger as described in claim 1, wherein the charging assembly comprises a solar panel so as to gather any external light available, a controller, and a connecter, and the lower housing is made of transparent material.

9. The waterproof battery charger as described in claim 8, further comprising a resilient member disposed on the solar panel that provides an elastic force against the electronic device which presses it.

10. The waterproof battery charger as described in claim 9, wherein the resilient member is made of flexible rubber or plastic.
